(19) United States
(12) Patent Application Publication
(10) Pub. No.: US 2013/0032494 A1
(43) Pub. Date: Feb. 7, 2013

(54) PORTABLE DEVICE FOR ANALYSING pH OR ANOTHER VARIABLE BY ELECTROCHEMICAL MEASUREMENT

(71) Applicants: Isabel Gomila Muñoz, Palma de Mallorca (ES); Feliciano Grases Freixedas, Palma de Mallorca (ES); Antonia Costa-Bauza, Palma de Mallorca (ES); Rafael M. Prieto Almirall, Palma de Mallorca (ES); Eva Martín Becerra, Palma de Mallorca (ES); Bernat Isern Amengual, Palma de Mallorca (ES); Ruben Henríquez Peláez, Palma de Mallorca (ES); Joan Perelló Berstard, Palma de Mallorca (ES)

(72) Inventors: Isabel Gomila Muñoz, Palma de Mallorca (ES); Feliciano Grases Freixedas, Palma de Mallorca (ES); Antonia Costa-Bauza, Palma de Mallorca (ES); Rafael M. Prieto Almirall, Palma de Mallorca (ES); Eva Martín Becerra, Palma de Mallorca (ES); Bernat Isern Amengual, Palma de Mallorca (ES); Ruben Henríquez Peláez, Palma de Mallorca (ES); Joan Perelló Berstard, Palma de Mallorca (ES)

(21) Appl. No.: 13/515,719

(22) PCT Filed: Dec. 14, 2010
(86) PCT No.: PCT/ES10/70828

§ 371 Date: Aug. 9, 2012

(30) Foreign Application Priority Data
Dec. 14, 2009 (ES) U200930750

(51) Int. Cl. G01N 27/26

(52) U.S. Cl. 205/787.5; 204/403.01; 204/403.02; 205/792; 205/775

(57) ABSTRACT

Portable device (1) for analysing pH or another variable by electrochemical measurement comprising a sensor (2), a microprocessor (3) and display means (4) for the results of the analysis. The portable device makes it possible to carry out pre-diagnoses quickly and easily without the need for specialist staff.

This invention is a portable device for analysing pH or another variable by electrochemical measurement, which makes it possible to carry out pre-diagnoses quickly and easily without the need for specialist staff.

### BACKGROUND OF THE INVENTION

Renal lithiasis is a pathology caused by the crystalisation of different substances in the urinary tract. More specifically, the crystalisation of uric acid always occurs in urine with a pH lower than 5.5. There are various factors that contribute to the formation of kidney stones, as well as hyperuricosuria.

It must be taken into account that the pKa of uric acid is approximately 5.5. This is the pH at which the ionic and non-ionic species of uric acid are balanced. Therefore, urine with a pH lower than 5.5 presents a higher proportion of undissociated (insoluble) forms that facilitate the formation of uric acid crystals and kidney stones.

On the other hand, the crystalisation of calcium phosphate in the form of hydroxyapatite [Ca₁₀(PO₄)₆(OH)₂], always occurs at a urinary pH higher than 6. There are other factors that contribute to the formation of hydroxyapatite stones, such as the presence or absence of crystalisation inhibitors or supersaturation, as a thermodynamic factor.

Finally, the crystalisation of calcium oxalate is caused by heterogeneous nucleation where, at a very high percentage, uric acid crystals or hydroxyapatite crystals can act as heterogeneous nuclei in the formation of calcium oxalate crystals.

One of the problems to be solved is the lack of portable devices that can easily and effectively measure the risk of kidney stones forming (consequence of urinary pH or other altered factors) in the urine of lithiasic patients or in healthy people who wish to prevent calcium oxalate, uric acid and hydroxyapatite lithiasis.

Although this check could be carried out using pH indicator paper or a similar system, we must point out that the precision of said systems is not enough to distinguish 0.1 pH units and therefore it would be difficult to obtain a diagnostic value regarding the risk of developing lithiasis.

In addition, the majority of pH metres with a digital or analogue indicator are difficult for patients to use, interpret and maintain and involve a high cost for individual use.

### DESCRIPTION OF THE INVENTION

To achieve the foregoing objects, this invention is a portable device for analysing pH or another variable by electrochemical measurement in accordance with claim 1, the use of a portable analysis device in accordance with claim 15 and a method for measuring pH or another variable by electrochemical measurement in accordance with claim 19. In the dependent claims, preferred embodiments of this invention are defined.

In a preferred embodiment the portable pH analysis device comprises a pH sensor, a microprocessor and display means for the results of the analysis, and is characterised for having three light indicators, the microprocessor being configured to activate:
the first of these indicators when the pH is lower than an initial pH threshold,
the second of these indicators when the pH is higher than a second pH threshold and,
the third of these indicators when the pH is between the abovementioned first and second thresholds.

Thus, this device will be useful to lithiasic patients, in that they can determine for themselves and with precision the effects of a diet and even food, drinks and dietary supplements, medicines or physical activity on the risk of kidney stone formation. More specifically, for patients who present a clear risk of lithiasis from uric acid or hydroxyapatite, as well as for those who are at risk of oxalocalcium lithiasis. We must point out that preventing the crystalisation of uric acid and hydroxyapatite would also indirectly prevent oxalocalcium lithiasis in a very high percentage of cases.

Preferably, the device in accordance with the invention is configured in the form of an adaptable lid for a urine specimen collection cup, the pH sensor being arranged to enter into contact with a urine sample inside the cup, once the device is affixed to the cup, thus allowing the device to be used under hygienic conditions and providing an effective reading, where possible placing the electrode in a suitable position with regard to the sample.

Ideally, the first pH threshold is 5.5 and the second threshold is 6.

Advantageously, the pH sensor comprises a pH electrode and a reference electrode for measuring the proton electrochemical potential in the urine.

A further benefit is that the device includes means for measuring the temperature in the pH and reference electrodes.

Finally, on the device of the invention, the first indicator is red, the second is blue and the third is green. The device can be fitted with additional sensors for measuring a variable by electrochemical measurement such as calcium or redox potential.

In a second aspect of the invention, the use of a device is defined in accordance with the first aspect of the invention for measuring pH or another variable by electrochemical measurement in a biological fluid sample. The biological fluid is preferably urine, although it may be another fluid, for example blood, saliva or sputum.

In a third aspect of the invention a method of measuring pH or another variable by electrochemical measurement of a sample is defined, which involves measuring pH or another variable by electrochemical measurement of the sample and providing an indication of the results of the measurement, depending on it being within at least one range of values.

### BRIEF DESCRIPTION OF THE DRAWINGS

In order to achieve a better understanding of what has been presented, some drawings have been attached in which a practical case of use is represented schematically and only as a non-limitative example.

FIG. 1 is a cross section of the preferred embodiment of the invention in which it is configured in the form of a lid affixed to a specimen cup.

FIG. 2 is a block diagram showing the essential elements of the device of the invention.

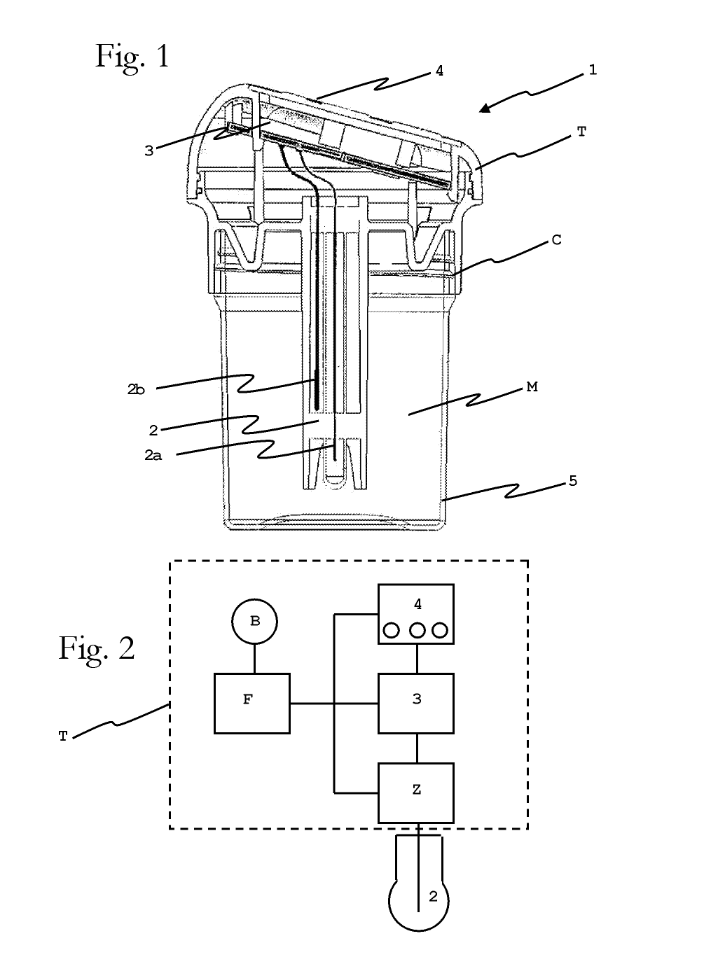

### DESCRIPTION OF A PREFERRED EMBODIMENT

As illustrated in the diagrams, in a particular embodiment the invention refers to a portable device 1 for analysing pH in urine M with a pH sensor 2, a microprocessor 3 and display means 4 for the results of the analysis.

More specifically, the invention is characterised for having three light indicators 4a, 4b and 4c, the microprocessor being configured to activate:
the first of these indicators 4a when the pH is lower than an initial pH threshold,
the second of these indicators 4b when the pH is higher than a second pH threshold and,
the third of these indicators 4c when the pH is between the abovementioned first and second thresholds.

Thus, any user can carry out a pre-diagnosis without the need to seek medical advice. Likewise, this could also be a pre-diagnosis tool for medical staff.

In accordance with the preferred embodiment of the invention, the device is configured in the form of a lid T which can be adapted to a urine M specimen cup 5.

The pH sensor 2 is arranged to enter into contact with a urine sample M contained in the cup 5, when the device 1 is attached to the cup 5, in such a way that adequate hygiene conditions are ensured and the correct placement of the electrodes is guaranteed with regards to the urine sample collected in the cup 5.

As has already been specified, the first threshold is 5.5, meaning that a lower reading indicates the capacity of nucleation and formation of uric acid crystals, which at the same time can become growth nuclei for calcium oxalate crystals. The second threshold is 6, meaning that the detection of a pH higher than this second threshold indicates the capacity of nucleation and growth of hydroxyapatite crystals, which can at the same time act as a nucleant for the calcium oxalate crystals.

The pH sensor 2 comprises a pH electrode 2a and a reference electrode 2b for measuring the proton electrochemical potential in the urine.

Calibration of the equipment is very simple, it only being necessary to replace the measuring cup with a test cup, which must contain a standard solution.

Likewise, in accordance with this preferred embodiment, the device contains means for measuring the temperature in the pH electrodes 2a and reference electrodes 2b.

As can be seen in diagram 2, the reading electrodes 2 protrude from the lid, and housed inside the lid is the battery B, the power source F, the electrode impedance adaptor Z, the microprocessor 3 and the indicator lights 4, connected together as shown in the diagram.

Using the device is extremely simple and consists of the following stages:

1. Separate the cup from the rest of the instrument by unscrewing the lid.

2—The patient deposits the urine in the cup

3—Screw the lid back on and shake lightly.

4—Press a test key.

5—In accordance with this preferred embodiment, the three lights will blink in sequence for a few seconds to indicate that the measurement is being taken. The result has been obtained when one of the lights stays lit.

6—Unscrew the lid, throw away the contents and wash both the cup, as well as the lid, with plenty of water before using again.

7—Screw the two parts together again so that some drops of water stay inside.

1. A portable device for analysing pH or another variable by electrochemical measurement, which comprises a sensor, a microprocessor and display means for the results of the analysis.

2. A device in accordance with claim 1 in which the display means for the results of the analysis comprise digital numbers and/or letters.

3. A device in accordance with claim 1 in which the display means for the results of the analysis comprise at least one light indicator.

4. A device in accordance with claim 1 which comprises three light indicators, the microprocessor being configured to activate:
the first of these indicators when the pH or another variable by electrochemical measurement is lower than an initial threshold,
the second of these indicators when the pH or another variable by electrochemical measurement is higher than a second threshold and,
the third of these indicators when the pH or another variable by electrochemical measurement is between the abovementioned first and second thresholds.

5. A device in accordance with claim 1, which is configured in the form of a lid that can be affixed to a specimen collection cup, the sensor being arranged to enter into contact with a sample contained in the cup, when the device is attached to the cup.

6. A device in accordance with claim 4, in which the abovementioned initial pH threshold is 5.5 and the second pH threshold is 6.

7. A device in accordance with claim 1, whereby, when the sensor is a pH sensor, it includes a pH electrode and a reference electrode for measuring the proton electrochemical potential in the urine.

8. A device in accordance with claim 7, which comprises means for measuring the temperature in the pH electrodes and the reference electrodes.

9. A device in accordance with claim 4, in which:
the first of the indicators is red,
the second of the indicators is blue and,
the third of the indicators is green.

10. A device in accordance with claim 1, which comprises a power source and/or a battery.

11. A device in accordance with claim 10, in which the power source is charged using sunlight.

12. A device in accordance with claim 1 which comprises an electrochemical sensor for measuring at least one variable by electrochemical measurement.

13. A device in accordance with claim 12 whereby the variable by electrochemical measurement is calcium.

14. A device in accordance with claim 12 whereby the variable by electrochemical measurement is the redox potential.

15. Use of a device in accordance with claim 1 for the measurement of pH or another variable by electrochemical measurement in a sample of fluid of biological origin.

16. Use of a device in accordance with claim 1 for the measurement of a variable by electrochemical measurement.

17. Use in accordance with claim 15 whereby the fluid of biological origin is urine.

18. Use of a device in accordance with claim 1 for the measurement of pH levels in a water sample.

19. Method for measuring a sample which comprises:
measuring the pH or another variable by electrochemical measurement of the sample, and providing an indication of the results of the measurement depending on what is found within at least one range of values.

20. Method in accordance with claim 19 which involves measuring a variable by electrochemical measurement.
